(19) United States
(12) Patent Application Publication
(10) Pub. No.: US 2004/0155767 A1
(43) Pub. Date: Aug. 12, 2004

(54) Multi-function self-canceling turn signal device with integrated voltage regulator

(76) Inventor: Gary Alan Hankins, Anna, OH (US)

Correspondence Address: Gary Hankins, 304 Onyx Drive, Anna, OH, 45302-0091, US

(21) Appl. No.: 10/770,048

(22) Filed: Feb. 2, 2004

Related U.S. Application Data
(60) Provisional application No. 60/445,488, filed on Feb. 6, 2003.

(51) Int. Cl. B60Q 1/40

(52) U.S. Cl. 340/476

(57) ABSTRACT

This device was invented: to eliminate the unsafe condition created by a motorcycle or other vehicle's turn signal indicator operating when no turn is intended; to provide multiple means of operating and controlling a motorcycle or other vehicle's turn signal indicator, to add an emergency four-way flasher system to a motorcycle or other vehicle not previously equipped with such; to provide a means of verifying the functionality of the motorcycle or other vehicle's turn signal indicators before entering the highway or traffic.

### RELATION TO PREVIOUSLY FILED APPLICATIONS

Priority is claimed from applicant's co-pending U.S. provisional patent application serial No. 60/445,488 filed on Feb. 6, 2003 entitled “Self-canceling turn signal control module with integrated voltage regulator”. Applicant incorporates said application herein by reference.

### FIELD OF THE INVENTION

The embodiment of the device for which exclusive property rights and privilege being claimed lies in the field of automated turn signal control devices often referred to as “self-canceling turn signals” or “turn signal control modules” more particularly for motorcycles or other vehicles which require banking or leaning to complete a turning maneuver.

### BACKGROUND OF THE INVENTION

A typical motorcycle turn indicator control system consists of a manual switch or switches mounted on the handle bars, an electromechanical or solid state flasher relay and incandescent light bulbs or light emitting diode arrays which are mounted front and rear to the left and right of the vehicle in such a manner as to provide clear view of the vehicles intended action. The handle bar mounted switch is activated manually by the vehicle operator prior to commencing a turning maneuver. The switch typically locks into position sending electrical current to the electromechanical or solid state flasher relay which in turn supplies intermittent current to the incandescent light bulbs or light emitting diode array which generates a flashing or blinking indication of the vehicle operator's intended action. The flashing or blinking indication of this intended action continues as long as the handle bar mounted switch is locked into position. The vehicle operator must manually disable the handle bar mounted switch to cancel the turn signal indicator circuit upon completion of the turning maneuver. The act of manually disabling the switch is easily overlooked or forgotten. A vehicle traveling with the turn signal indicator enabled when no turn is intended is unsafe thereby creating a confusing, hazardous and potentially dangerous condition for the vehicle operator and others sharing the roadway. The device disclosed herein eliminates this unsafe operating condition by replacing the manual cancellation function of the turn signal indicator control switch with the convenience and reliability of electronics. Furthermore, many makes and models of motorcycles are not equipped with four-way emergency flashers as standard equipment. The device disclosed herein supplements the aforementioned safety considerations through the addition of an emergency four-way flasher function.

### DESCRIPTION OF PRIOR ART

U.S. Pat. No. 3,876,976 to Cross discloses a manually initiated directional signaling system utilizing a handle bar mounted manual activation switch and mercury tilt switches to automatically cancel the turn signal upon making the turning maneuver. Manacci (U.S. Pat. No. 4,363,022) describes a system that utilizes a 555 timer in conjunction with mercury tilt switches and silicon controlled rectifiers to generate and automatically cancel the turn indicator signal. U.S. Pat. No. 6,414,593 to Conner, et al. reveals an inventive system utilizing a microprocessor and a curved track. The curved track which contains electrical contacts on either end of the track holds an electrically conductive ball that travels within the track. As the vehicle tilts or leans as in a turning maneuver, the ball makes contact at either end of the track sending an output signal to the microprocessor which in turn cancels the turn signal indicator. Similarly, Tzanev (U.S. Pat. No. 5,777,290) details a system utilizing a “V” shaped channel containing a movable ball for sensing less than vertical vehicle position as a means of controlling electrical functions such as a turn signal indicator. U.S. Pat. No. 6,304,804 to DeBoni details the use of accelerometers to accomplish the same means. U.S. Pat. No. 6,424,255 to Shanahan; U.S. Pat. No. 4,361,289 to Kramholler et al.; U.S. Pat. No. 5,519,378 to Queensbury; U.S. Pat. No. 4,924,208 to Coughlin; U.S. Pat. No. 4,241,328 to Lobe et al.; U.S. Pat. No. 5,414,407 to Gerrans et al. and U.S. Pat. No. 5,309,143 to Brown et al. describe diverse devices for providing audio-visual feed back and for monitoring and controlling various aspects of a motorcycle or other vehicle turn signal indicator.

All the patents above describe various devices for controlling a motorcycle or other vehicle turn signal indicator. Some patents rely on complicated speed, distance and position sensors, which are prone to error depending on vehicle speed and road surface conditions. Some of these patents describe various add-on devices, which detract from the appearance of the motorcycle or other vehicle. This factor is critical to the owners of these vehicles. Other patents describe various devices which rely on mercury tilt sensing switches which, through the design of the device, are prone to premature and unreliable deactivation and limited scope of application by failing to consider diverse vehicle designs, unique vehicle turning characteristics and other factors which have an impact on the functionality of these described devices. Yet other patents describe devices that act only as a reminder, emitting audio/visual feedback after a period of time to alert the vehicle operator that the turn signal indicator is active whereas the vehicle operator must manually de-activate the turn signal indicator. Another type of device substitutes the original equipment flasher control with a unit that will automatically deactivate the turn signal indicator after a preset period of time. But, this device also uses the original equipment activation switch which must still be deactivated before the device can be used again for the next turning maneuver. Furthermore, the front or rear brake must be engaged to prevent this device from prematurely canceling the turn signal indicator. Holding a brake lever in this fashion may result in rapid fatigue or loss of vehicle balance which brings about additional safety concerns.

None of the above patents contain, describe or teach individually or in combination thereof all the unique features, advantages, structure and/or function of the subject multi-function self-canceling turn signal device with integrated voltage regulator.

### SUMMARY OF THE INVENTION

Those skilled in the art will recognize that the foregoing example and description of this inventive turn signal indicator control system is susceptible of modification in many ways without departing from the scope of the device. This example and its description is not intended to limit the scope of this device as it will become apparent to those skilled in the art that modification of the device and the embodiments described herein will not depart from the basic operating concept or principles of design of said device, that upon reviewing the detailed description, showing novel construction and combination of elements as herein described, and more particularly defined by the claims, it being understood that changes in the embodiments to the herein disclosed device are meant to be included as coming within the scope of the claims.

The device described herein mounts on the chassis of the motorcycle or other vehicle thereby placing the device and its associated hardware out of plain view. This retains the appearance of the motorcycle or other vehicle thereby affording suitability for installation as original equipment or as an after market device without appearing as an ungainly add-on.

This description of said device utilizes standard electronic components to accomplish three primary functions: First to provide a means of timely deactivation of the turn signal indicator without requiring human interaction upon completion of a turning maneuver; Secondly to provide a means of indicating a highway lane change or a passing maneuver with timely deactivation of the turn signal indicator without requiring human interaction; Thirdly to provide an emergency four-way flasher system to indicate distress or for increased vehicle visibility during adverse weather conditions. This description of said device utilizes standard electronic components to accomplish four secondary functions: First to provide a means of manually deactivating the turn signal indicator if the vehicle operator desires to do so; Secondly to provide a means of converting the time controlled function (i.e. lane change indicator) to the continuos function or vice versa; Thirdly to provide a time controlled four-way flasher mode; Lastly to provide an initial power up test sequence to verify that the vehicle's turn signal system is functioning properly.

An electrical system of a motorcycle or other vehicle is typically “noisy”, having a notable increase in voltage supplied to the electrical circuitry at engine idle speed versus engine highway speed. This voltage also contains a fairly significant alternating current ripple factor. This inconsistency in voltage and the associated ripple factor must be removed so the control and logic circuitry of the device can operate consistently, reliably and without the possible risk of damage to the sensitive electronics resulting from transient voltage and current. This description of said device therefore utilizes an integrated voltage regulator known to those skilled in the art as an LM7805 integrated voltage regulator.

This example of the device described herein utilizes dual integrated timer circuits known to those skilled in the art as the 556 dual timer as the controller. A single 556 dual timer contains two identical comparator circuits. The design of the 556 dual timer allows both internal circuits to function independently or in conjunction with one another. This example of the device described herein utilizes these characteristics to their fullest advantage considering a motorcycle or other vehicle has both a left side and right side turn signal indicator circuit. One 556 dual timer is used to control the motorcycle or other vehicle's left side turn signal indicator circuit, a second 556 dual timer is used to control the motorcycle or other vehicle's right side turn signal indicator circuit. One half of each dual timer is used to generate the time controlled functions of the left and right hand turn signal indicator, the second half of each dual timer is used to generate and control the continues function of the left and right hand turn signal indicator. Simultaneously using both halves of the 556 dual timers which generate the time controlled functions of the left and right hand turn signal indicator generates a time controlled emergency four-way flasher function. Simultaneously using both halves of the 556 dual timers which generate and control the continuos functions allows activation and control of both left and right side motorcycle or other vehicle turn signal indicators to generate a continues emergency four-way flasher function.

A position sensor is used in this embodiment to provide relative vehicle position information to the controller. As the vehicle is banked or leaned to complete a turning maneuver, the position sensor detects this change in angular position then sends data to the controller. The controller interprets this data and deactivates the turn signal indicator accordingly. This example of the device described herein overcomes the problem of premature and unreliable deactivation noted in previous inventions utilizing similar position sensing devices through the use of an adjustable position sensor mounting system. Said adjustable mounting system allows compensation for physical characteristics unique to the motorcycle or other vehicle to which it is mounted as each motorcycle or other vehicle possesses unique turning characteristics. Operator style and riding habits also affect the operation of this type of sensing device. Counter steering, vehicle movement associated with riding position adjustment and personal operating traits are easily compensated for by using said mounting system. Therefore, the device as described herein can be readily adapted to any make, model or design of motorcycle or other vehicle.

These and other advantages of the device are apparent upon further study of these embodiments and the associated drawings.

### BRIEF DESCRIPTION OF THE DRAWINGS

FIG. 15 illustrates the circuit logic.

FIG. 25 illustrates one half of the control circuitry schematic of this description.

FIG. 35 illustrates the second half of the control circuitry schematic of this description.

FIG. 45 illustrates the components and makeup (two versions) of the adjustable position sensor mounting system.

FIG. 55 illustrates a two wheeled motorized vehicle in an upright position detailing angles of inclusion for clarification of FIG. 45.

### DETAILED DESCRIPTION OF THE ILLUSTRATED EMBODIMENTS

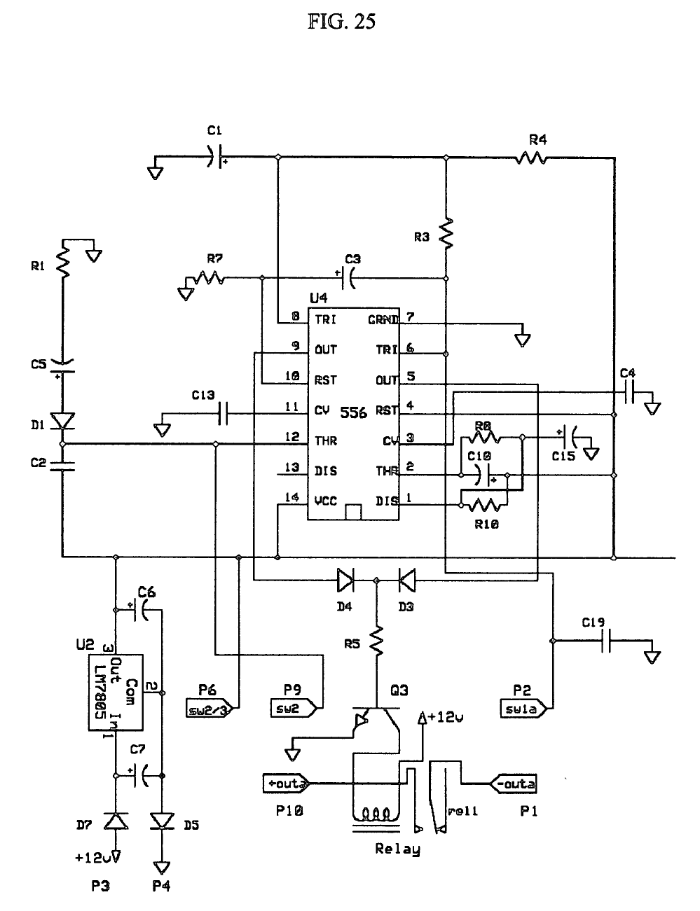

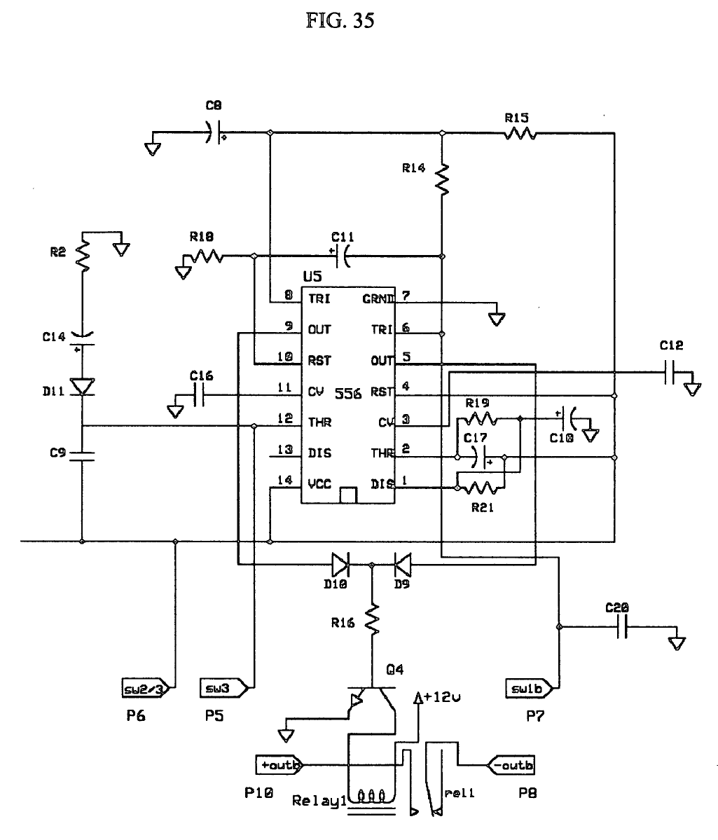

In this description of said device, reference will be made primarily to FIG. 25 to describe the operation of one 556 dual timer and its associated control circuitry as both dual timers, their associated control circuitry, function and operational modes are identical. Also, for this discussion, U4 of FIG. 25 will be assigned as controlling the vehicle's left turn signal indicator, U5 of FIG. 35 will be assigned as controlling the vehicle's right turn signal indicator. Those skilled in the art will easily recognize by jointly examining FIG. 25 and FIG. 35 how the second 556 dual timer and its associated control circuitry in combination with the first accomplish the features claimed. Those skilled in the art will also recognize from this description and associated drawings how the claimed features can be accomplished through the use of other electronic devices aside from the those cited herein, it being understood that changes in the embodiments to the herein disclosed device are meant to be included as coming within the scope of the claims.

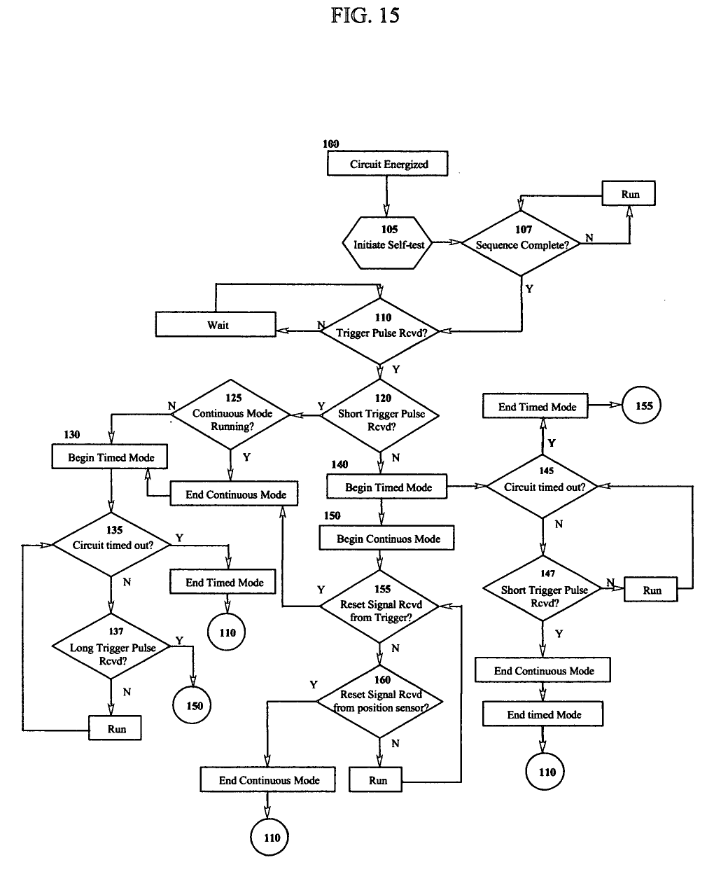

A test mode is initiated when power is first applied to the device at 100 of FIG. 15. When this sequence is complete, control of the device is directed to the trigger input at 110 of FIG. 15 and the device is ready to receive an input signal. If a short trigger pulse is received at 120 of FIG. 15 the controller immediately ends the continuous mode if it is operating then immediately begins the timed mode at 130. The controller continues to search for a signal pulse at 137 while the timed mode is running. If no signal pulse is received at 137, the circuit times out at 135 and the timed mode ends returning control of the device to 110. If a long signal pulse is received at 137 before the circuit times out, control of the device branches to 150 of FIG. 15 and the continuous mode begins. The controller looks for signal input at 155 and 160 while the continuous mode is running. If no signal is received, the continuous mode continues to run. If a reset signal is received from the trigger at 155, device control branches, the continuous mode ends and the timed mode begins at 130. If a reset signal is received from the position sensor at 160, the continuous mode ends immediately and control of the device returns to 110 of FIG. 15. If a long trigger pulse is received at 120, the timed mode begins at 140 and the continuous mode begins at 150. The controller looks for signal input at 147 until the circuit times out at 145. If a short trigger pulse is received at 147 while the timed mode is running, both the continuous and timed mode ends immediately and control of the device returns to 110 of FIG. 15. If no signal is received at 147 while the timed mode is running, control of the circuit branches to 155 when the circuit times out. The controller looks for signal input at 155 and 160 while continuous mode is running. If no signal is received, the continuous mode continues to run. If a reset signal is received from the trigger at 155, device control branches, the continuous mode ends and the timed mode begins at 130. If a reset signal is received from the position sensor at 160, the continuous mode ends immediately and control of the device returns to 110 of FIG. 15.

U2 (LM7805) of FIG. 25 is connected to the vehicle's voltage supply circuit through P3 and P4, P3 being the positive voltage input and P4 being the common input which is connected to the vehicle's ground path. U2 is fitted with diodes D5 and D7 on the common (Com) and input (In) side respectively to prevent damage caused by a reversed polarity hook up. Capacitor C7 is connected across the inputs of U2 and is sized to effectively filter out any alternating current ripple which may be present in the vehicle's voltage supply circuit. Capacitor C6 is sized to eliminate any ripple voltage that may persist in the output of U2. The output of U2 (Out) connects to VCC pin 14 of U4 (556 dual timer) providing positive supply voltage to U4. The output of U2 (Out) also supplies positive voltage to other components throughout the circuit and to VCC pin 14 of U5 (556 dual timer). GRND pin 7 of U4 and U5 is connected to the circuit ground path.

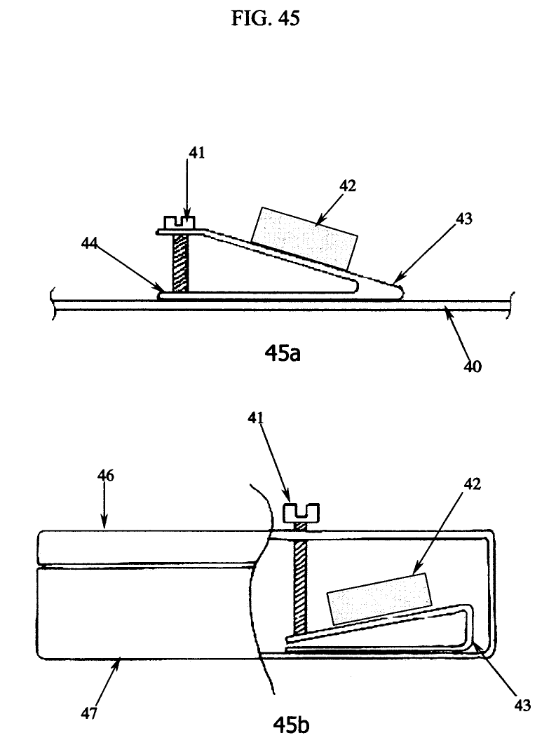

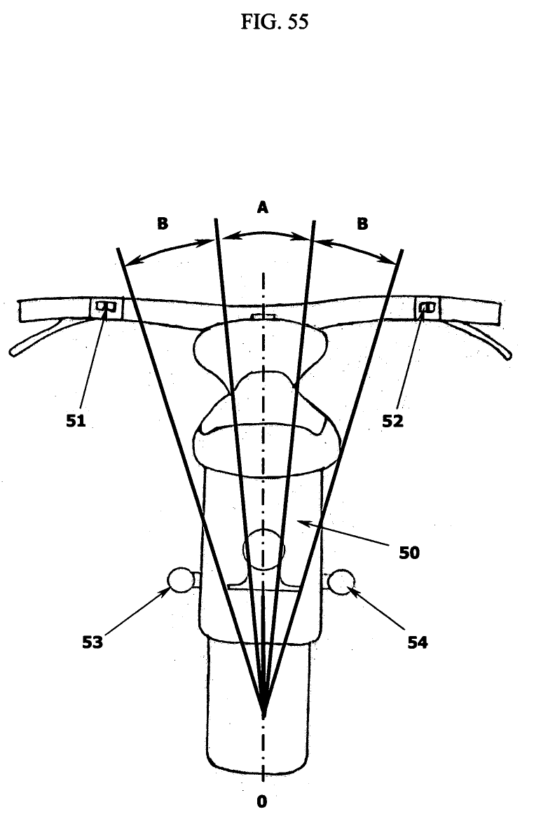

P6 (sw2/3) of FIG. 25 provides positive voltage to position sensor 42 of FIG. 45. P9 of FIG. 25 provides input from the position sensor (sw2) to the THR pin 12 of U4. P10 (+outa) is the positive voltage feed to the normally open contact of RELAY. This voltage is supplied directly from the motorcycle or other vehicle's flasher circuitry. P1 of FIG. 25 (−outa) is the common or ground connection of the normally open contact of RELAY which ties directly to the vehicle ground path. P2 of FIG. 25 (sw1a) provides trigger input from the manually operated turn signal indicator activation switch to TRI pin 6 of U4 and corresponds to switch 51 of FIG. 55. P2 is coupled to ground through capacitor C19 to reduce the effects of contact bounce of the turn signal indicator activation switch and to buffer against any transient voltage which may be present in the triggering circuit. P6 (sw2/3) of FIG. 35 provides positive voltage to position sensor 42 of FIG. 45. P5 of FIG. 35 provides input from the position sensor (sw3) to the THR pin 12 of U5. P10 (+outb) is the positive voltage feed to the normally open contact of RELAY1. Voltage to P10 is supplied directly from the motorcycle or other vehicle's flasher circuitry. P8 of FIG. 35 (−outb) is the common or ground connection of the normally open contact of RELAY1 which ties directly to the vehicle ground path. P7 of FIG. 35 (sw1b) provides trigger input from the manually operated turn signal indicator activation switch to TRI pin 6 of U5 and corresponds to switch 52 of FIG. 55. P7 is coupled to ground through capacitor C20 to reduce the effects of contact bounce of the turn signal indicator activation switch and to buffer against any transient voltage which may be present in the triggering circuit. Pins 1 through 6 of U4 and U5 generate and control the timed functions of this example of said device. Pins 8 through 12 of U4 and U5 control the continuous functions of this example of said device. RST pin 4 (U4 and U5) is tied to the circuit's positive voltage path. DIS pin 13 (U4 and U5) is not used and therefore has no physical connection.

A negative going ramp generator comprised of resistors R3, R4 and capacitor C1 of FIG. 25 tied to U4 TRI pin 6 and U4 TRI pin 8 controls the triggering of the continuous functions of said device. Capacitor C3 and resistor R7 tied to U4 pin 6 creates a feedback loop to U4 RST pin 10. Resistors R8, R10 and capacitors C10, C15 are tied to U4 DIS pin 1 and U4 THR pin 2 to provide the timing function and to allow a short power-up sequence for visual assurance that the vehicle's turn signal indicators are working. Capacitor C4 of FIG. 25 ties to U4 CV pin 3 to ground to eliminate the possibility of transient voltage affecting the operation of the comparator circuit contained in this half of U4. U4 OUT pin 5 ties into diode D3 which feeds resistor R5 which in turn supplies base current to transistor Q3. Transistor Q3 of FIG. 25 controls the operation of RELAY. When in the on state, transistor Q3 conducts heavily and allows voltage to flow through the coil of RELAY which in turn pulls in the normally open contact of RELAY allowing current to flow to the vehicle's turn signal indicator. Similarly, U4 OUT pin 9 ties into diode D4 which feeds resistor R5 which in turn supplies base current to transistor Q3. Capacitor C13 ties U4 CV pin 11 to ground to eliminate the possibility of transient voltage affecting the operation of the comparator circuit contained in this half of U4. Resistor R1, diode D1 and capacitors C2, C5 of FIG. 25 provide a power up reset function and voltage feed back loop to U4 THR pin 12.

Those skilled in the art will recognize that the 555 timer family possesses a characteristic that allows the 555 timer IC to trigger on the positive going voltage edge when power is first applied to it. This characteristic is not used in one half of U4 but is used in the other half of U4. On initial power up, capacitors C5 and C2 conduct heavily through resistor R1 allowing voltage to be applied to U4 THR pin 12 thereby instantly resetting the comparator circuit in this half of U4 causing U4 OUT pin 9 to remain in its low state. Capacitors C10 and C15 charge at a slower rate through resistors R8 and R10 allowing this half of U4 to cycle through the power up. This allows U4 OUT pin 5 to go high on initial power up sending voltage to the base of transistor Q3 through diode D3 and resistor R5. With voltage applied to the base of transistor Q3, transistor Q3 turns on and energizes the coil of RELAY. This pulls in the normally open contacts of RELAY and sends current to the vehicle's turn signal indicator circuitry. When the voltage on U4 THR pin 2 reaches ⅔Vcc, the flip-flop of the comparator of this half of U4 is reset forcing U4 OUT pin 5 to go low. With voltage no longer being applied to the base of transistor Q3, transistor Q3 turns off which causes RELAY to drop out thereby turning off the vehicle's turn signal indicator circuitry. The time for the voltage at U4 THR pin 2 to reach ⅔Vcc depends on the sizing of resistors R8, R10 and capacitors C10, C15. This sequence of events is identical for U5 of FIG. 35, i.e. both dual timers execute the same initial power up sequence. Therefore, it is easy to see by those skilled in the art that these events provide an initial power up sequence that tests the vehicle's turn signal control circuitry by engaging all the turn signal indicators simultaneously, in other words a short emergency four-way flasher sequence takes place upon initial power up.

Some vehicles use a single switch to manually activate the vehicle's turn signal indicator. Single switch arrangements typically place the switch on the left handle bar within easy reach of the thumb. This switch is typically a DPDT. Moving the DPDT switch in one direction (usually forward) engages the right turn signal indicator, moving it in the opposite direction (usually backwards) engages the left turn signal indicator. Some vehicles are equipped with dual switches. These switches are typically SPST. On vehicles equipped with dual switches, the left switch activates the left turn signal indicator, the right switch activates the right turn signal indicator. Irregardless of the switch configuration or pole type, the switch or switches must be of momentary type with one side of the switch grounded to the vehicle's ground path. FIG. 55 depicts a two wheeled motorized vehicle utilizing two activation switches.

Switch 51 of FIG. 55 corresponds to P2 (sw1a) of FIG. 25 as P2 provides the trigger input from the manually operated turn signal indicator activation switch to TRI pin 6 of U4. To activate the time controlled lane change indicator (120 of FIG. 15) for use as in a passing maneuver, or for merging into interstate or divided highway traffic, or for changing lanes on an interstate or divided highway, briefly engaging switch 51 of FIG. 55 causes U4 TRI pin 6 to approach ground potential. This triggers the flip-flop of the comparator circuit in this half of the dual timer and forces U4 OUT pin 5 to go high sending voltage to the base of transistor Q3 through diode D3 and resistor R5. With voltage applied to the base of transistor Q3, transistor Q3 turns on and energizes the coil of RELAY. This pulls in the normally open contacts of RELAY and sends current to the vehicle's left turn signal indicator 53 of FIG. 55. When the voltage on U4 THR pin 2 reaches ⅔Vcc, the flip-flop of the comparator of this half of U4 is reset forcing U4 OUT pin 5 to go low. With voltage no longer being applied to the base of transistor Q3, transistor Q3 turns off which causes RELAY to drop out thereby turning off the vehicle's turn signal indicator circuitry. The time for the voltage at U4 THR pin 2 to reach ⅔Vcc depends on the sizing of resistors R8, R10 and capacitors C10, C15. There is debate over what this exact timing interval should be for a vehicle to execute a passing maneuver or to merge into traffic but generally three to four seconds is acceptable. This sequence of events is identical for U5 of FIG. 35 with the exception that U5 may be controlled by switch 52 of FIG. 55 and U5 controls the vehicle's right turn signal indicator 54 of FIG. 55. On vehicles equipped with a single activation switch, moving switch in one direction (usually forward) engages the right turn signal indicator, moving it in the opposite direction (usually backwards) engages the left turn signal indicator.

To activate the continuous turn signal indicator (120 of FIG. 15) for use as in being stopped at a traffic light or moving slowly in heavy traffic, engaging switch 51 of FIG. 55 for a period of time equal to the R/C time constant as defined by the combination of FIG. 25 resistors R3, R4 and capacitor C1 causes two events to take place:

1. U4 TRI pin 6 to approaches ground potential. This triggers the flip-flop of the comparator circuit in this half of the dual timer and forces U4 OUT pin 5 to go high sending voltage to the base of transistor Q3 through diode D3 and resistor R5. With voltage applied to the base of transistor Q3, transistor Q3 turns on and energizes the coil of RELAY. This pulls in the normally open contacts of RELAY and sends current to the vehicle's left turn signal indicator 53 of FIG. 55.

2. U4 TRI pin 8 approaches ground potential. This triggers the flip-flop of the comparator circuit in this half of the dual timer and forces U4 OUT pin 9 to go high sending voltage to the base of transistor Q3 through diode D4 and resistor R5 and to the coil of RELAY.

When the voltage on U4 THR pin 2 reaches ⅔Vcc, the flip-flop of the comparator of this half of U4 is reset forcing U4 OUT pin 5 to go low. The time for the voltage at U4 THR pin 2 to reach ⅔Vcc depends on the sizing of resistors R8, RIO and capacitors C10, C15. When this side of the dual timer times out, RELAY is still energized by U4 OUT pin 9. Since this side of the dual timer has no timing components, U4 OUT pin 9 will remain in its high state and the left turn signal indicator will remain energized until one of three events take place:

1. The vehicle operator manually cancels the turn signal indicator (155 of FIG. 15) by briefly engaging switch 51 of FIG. 55 which sends a negative going pulse to U4 RST pin 10 through the feedback loop of capacitor C3 and resistor R7 which resets the flip-flop of the comparator in this side of U4 causing U4 OUT pin 9 to go low;

2. The turn is made in which case U4 THR pin 12 receives a voltage signal from the position sensor (160 of FIG. 15) which resets the flip-flop of the comparator in this side of U4 causing U4 OUT pin 9 to go low;

3. All power to the circuitry is removed.

This continuous function can be cancelled immediately after being started by briefly moving the activation switch in the appropriate direction before the timed mode times out (145 of FIG. 15). This sequence of events is identical for U5 of FIG. 35 with the exception that U5 may be controlled by switch 52 of FIG. 55 and U5 controls the vehicle's right turn signal indicator 54 of FIG. 55. On vehicles equipped with a single activation switch, moving switch in one direction (usually forward) engages the right turn signal indicator, moving it in the opposite direction (usually backwards) engages the left turn signal indicator. Moving the single switch in the appropriate direction for a period of time equal to the R/C time constant as defined by the combination of resistors R3, R4 and capacitor C1 allows the same sequence of events as described above to occur.

To activate the continuos four-way emergency flasher function for indicating distress or for increased visibility in an adverse weather condition, engaging switch 51 and 52 of FIG. 55 simultaneously for a period of time equal to the R/C time constant as defined by the combination of FIG. 25 resistors R3, R4 and capacitor C1 of U4 and FIG. 35 resistors R14, R15 and capacitor C8 of U5 causes two events to take place:

1. U4 and U5 TRI pin 6 approaches ground potential. This triggers the flip-flop of the comparator circuit in this half of both of the dual timers and forces U4 and U5 OUT pin 5 to go high sending voltage to the base of transistor Q3 through diode D3 and resistor R5 of FIG. 25 and transistor Q4 through diode D9 and resistor R16 of FIG. 35. This pulls in the normally open contacts of FIG. 25 RELAY and sends current to the vehicle's left turn signal indicator 53 of FIG. 55. With voltage applied to the base of transistor Q4, transistor Q4 turns on and energizes the coil of FIG. 35 RELAY1 and sends current to the vehicle's right turn signal indicator 54 of FIG. 55.

2. U4 and U5 TRI pin 8 approaches ground potential. This triggers the flip-flop of the comparator circuit in this half of both of the dual timers and forces U4 and U5 OUT pin 9 to go high sending voltage to the base of FIG. 25 transistor Q3 through diode D4 and resistor R5 and to the coil of RELAY and sending voltage to the base of FIG. 35 transistor Q4 through diode D9 and resistor R16 and to the coil of RELAY1.

When the voltage on U4 and U5 THR pin 2 reaches ⅔Vcc, the flip-flop of the comparator of this half of both U4 and U5 is reset forcing U4 and U5 OUT pin 5 to go low. The time for voltage at U4 and U5 THR pin 2 to reach ⅔Vcc depends on the sizing of FIG. 25 resistors R8, RIO and capacitors C10, C15 and the sizing of FIG. 35 resistors R17, R19 and capacitors C17, C18. When this side of the dual timers times out, RELAY and RELAY1 is still energized by U4 and U5 OUT pin 9. Since this side of both dual timers has no timing components, U4 and U5 OUT pin 9 will remain in its high state and the vehicle's left and right turn signal indicator will remain energized until one of three events take place:

1. The vehicle operator manually cancels the turn signal indicator by briefly engaging switch 51 and 52 of FIG. 55 which sends a negative going pulse to U4 and U5 RST pin 10 through the feedback loop of capacitor C3 and resistor R7 and capacitor C11 and resistor R18 which resets the flip-flop of the comparator in this side of U4 and U5 causing U4 and U5 OUT pin 9 to go low;

2. The operator tips the vehicle from side to side in which case U4 and U5 THR pin 12 receives a voltage signal from the position sensor which resets the flip-flop of the comparator in this side of U4 and U5 causing U4 and U5 OUT pin 9 to go low;

3. All power to the circuitry is removed.

This continuous function can be cancelled immediately after being started by briefly moving the activation switch in the appropriate direction before the timed mode times out (145 of FIG. 15). On vehicles equipped with a single activation switch, moving the switch in one direction (usually forward) and holding it for a period of time equal to the R/C time constant as defined by the combination of FIG. 35 resistors R14, R15 and capacitor C8 of U5 engages the right turn signal indicator, moving it in the opposite direction (usually backwards) and holding it for a period of time equal to the R/C time constant as defined by the combination of FIG. 25 resistors R3, R4 and capacitor C1 of U4 engages the left turn signal indicator thereby enabling the continuos four-way emergency flasher function. This function can be manually cancelled by moving the single switch first in one direction then in the opposite direction without pausing or by either of the other two remaining means listed above.

The continuos functions (150 of FIG. 15), once engaged as described in the text above, can be converted to the timed functions through the turn signal indicator activation switch or switches. The continuous turn signal indicator, either left or right, is converted to the timed indicator (155 of FIG. 15) by briefly engaging switch 51 or 52 of FIG. 55 which sends a negative going pulse to U4 or U5 RST pin 10 through the feedback loop of FIG. 25 capacitor C3 and resistor R7 or FIG. 35 capacitor C11 and resistor R18 which resets the flip-flop of the comparator in this side of either U4 or U5 causing U4 or U5 OUT pin 9 to go low thereby turning off the continuous function. At the same time, U4 or U5 TRI pin 6 approaches ground potential. This triggers the flip-flop of the comparator circuit in this half of either dual timer and forces U4 or U5 OUT pin 5 to go high sending voltage to the base of FIG. 25 transistor Q3 through diode D3 and resistor R5 to RELAY or to FIG. 35 transistor Q4 through diode D9 to resistor R16 to RELAY1 thereby activating the timed mode (130 of FIG. 15). Transistor Q3 or Q4 remains conductive which allows current to keep flowing to RELAY or RELAY1 for a period time determined by the R/C time constant of FIG. 25 resistors R8, RIO and capacitors C10, C15 (U4) or FIG. 35 resistors R19, R21 and capacitors C17, C18 (U5). On vehicles equipped with a single activation switch, briefly moving the switch in one direction (usually forward) converts the right turn signal indicator, or, briefly moving the switch in the opposite direction (usually backwards) converts the left turn signal indicator.

Similarly, the timed functions (130 of FIG. 15) once engaged as described above, can be converted to the continuous functions through the turn signal indicator activation switch or switches. The timed turn signal indicator function, either left or right, is converted to the continuous indicator function (137 of FIG. 15) by engaging switch 51 or 52 of FIG. 55 for a period time equal to the R/C time constant as determined by the combination of FIG. 25 resistors R3, R4 and capacitor C1 of U4 or as determined by FIG. 35 resistors R14, R15 and capacitor C8 of U5 before the lapse of the R/C time constant as determined by FIG. 25 resistors R8, R10 and capacitors C10, C15 (U4) or FIG. 35 resistors R19, R21 and capacitors C17, C18 (U5). On vehicles equipped with a single activation switch, moving the switch in one direction (usually forward) for a period time equal to the R/C time constant as determined by the combination of FIG. 35 resistors R14, R15 and capacitor C8 of U5 converts the right turn signal indicator, or, moving the switch in the opposite direction (usually backwards) for a period of time equal to the R/C time constant as defined by the combination of FIG. 25 resistors R3, R4 and capacitor C1 of U4 converts the left turn signal indicator.

A timed four-way flasher function is activated by briefly engaging switch 51 or 52 of FIG. 55 simultaneously or in succession. The four-way flasher function will operate for a period of time as determined by the R/C time constant of FIG. 25 resistors R8, R10 and capacitors C10, C15 of U4 or FIG. 35 resistors R19, R21 and capacitors C17, C18 of U5. On vehicles equipped with a single activation switch, briefly moving the switch first in one direction (usually forward) engages the right turn signal indicator then briefly moving the switch in the opposite direction (usually backwards) engages the left turn signal indicator thereby engaging the timed emergency four-way flasher mode. This timed mode can be converted to the continuous mode as described above.

The adjustable position sensor mounting system is depicted in FIG. 45. The adjustable position sensor mounting base 43 of FIG. 45a made of spring steel or any type material capable of providing resilient spring like resistance is mounted to printed circuit board 40. The adjusting device of this example is screw 41 which passes through the top of mounting base 43 and passes through the mating threaded substrate 44 below. Passage for excess length of adjusting screw 41 is allowed through printed circuit board 40 by means of a through hole. FIG. 45a illustrates position sensor mounting base 43 in its at rest position at which point position sensor 42 will send a continuos signal to the controller. Turning screw 41 clockwise decreases the inclination of position sensor 42 toward the horizontal. FIG. 55 illustrates a motorized two wheeled vehicle 50 in a vertical position having a centerline 0 indicating normal straight line motion while perpendicular to the horizon. Inclusive angle A indicates typical vehicle movement in instances of counter steering and normal riding position adjustments. Exclusive angle B indicates a true turning maneuver either left or right and the angle of lean during such maneuver. Position sensor 42 is attached to mounting base 43 and the inclination of mounting base 43 is corrected to coincide with inclusive angle A of FIG. 55 using screw 41.

FIG. 45b illustrates subject adjustable position sensor mounting system alternately placed in an enclosure. The position sensor mounting base 43 of FIG. 45b made of spring steel or any type material capable of providing resilient spring like resistance is mounted in enclosure 47. The adjusting device of this description is screw 41 which passes through the top 46 of enclosure 47 and rests on the top of mounting base 43. FIG. 45b depicts mounting base 43 at its maximum rate of compression thereby placing position sensor 42 in its least sensitive setting. Turning screw 41 counter-clockwise decreases the inclination of mounting base 43 toward the horizontal. Position sensor 42 of FIG. 45b is attached to mounting base 43 and the inclination of mounting base 43 is corrected using screw 41 to coincide with the inclusive angle A of FIG. 55.

The adjustable position sensor mounting system provides allowance for conservative deviation from FIG. 55 centerline 0, this deviation being typical of counter steering or adjustments to riding position and the position of the vehicle during this movement. Said adjustable mounting base also allows correction of position sensor 42 to compensate for differing geometric and physical characteristics peculiar to any make or model of motorcycle or other vehicle. This need will appear obvious to those skilled in the art as each design or type of motorcycle or other vehicle exhibits unique turning radii and/or turning attributes. Utilizing this type of position sensor mounting system overcomes the problems of previous designs using similar position sensors thusly eliminating premature deactivation of the turn signal indicator as a result of the factors stated above. With the correct adjustment for any specific vehicle, the position sensor will communicate relative vehicle position information accurately and effectively to the controller to deactivate the vehicle's turn signal indicator circuitry at the precise exclusive angle B of FIG. 55 which indicates a true turning maneuver either left or right.

I claim:

1. An automatic turn signal indicator control device which contains an integrated voltage supply regulator, said device automatically cancels the turn signal indicator and provides multiple turn signal indicator control functions for use on a motorcycle or other vehicle.

2. An adjustable position sensor mounting system for use with said device or other devices that depend on detection of angular deviation for operation.

3. Said device as described in claim 1 is adaptable to any vehicle which relies on banking or leaning to complete a turning maneuver.

4. Said device as described in claim 1 performs an initial power up sequence to verify that the vehicle's turn signal control system is functioning properly.

5. Said device as described in claim 1 is operated by a manual turn signal indicator activation switch or switches which may be of single pole or multiple pole design.

6. Said device as described in claim 1 provides multiple turn signal indicator control functions by:
automatic deactivation of the vehicle's turn signal indicator;
a continuous indicator function for use as in being stopped at a traffic control signal or moving slowly in heavy traffic;
a time controlled indicator function for use as in a passing maneuver, or for merging into interstate or divided highway traffic, or for changing lanes on an interstate or divided highway;
a continuous emergency four-way flasher function to indicate distress or to increase the visibility of the vehicle during adverse weather conditions;
a time controlled emergency four-way flasher function to indicate distress or to increase the visibility of the vehicle during adverse weather conditions;
manual deactivation, if desired, in the event the vehicle operator decides not to execute a previously anticipated turning maneuver;
conversion of the continuous functions above into the timed functions;
conversion of the timed functions above into the continuous functions.

7. Said device as described in claim 6 provides multiple turn signal indicator control functions through sequential operation of the vehicle's turn signal indicator activation switch or switches.

8. Said device as described in claim 6 contains:
a voltage regulator configured to provide a constant unerring voltage supply to the control circuitry;
the control circuitry consisting of capacitors, resistors, diodes and/or any logic, memory or other signal processing device or devices necessary to provide the required control logic to the controller,
a controller or signal processing device such as a linear IC, PROM, microprocessor or other signal processing device or combination of these devices thereof;
a means of directing and controlling the output of the controller to the vehicle's turn signal indicator circuitry said means consisting of transistors and/or electromechanical or solid state relays or other silicon controlled devices or any combination of these devices thereof;
all of which is mounted to a printed circuit board individually or as a single hybrid IC or any combination thereof through conventional or surface mount technology.

9. Said adjustable position sensor mounting system of claim 2 consists of a base constructed of spring steel or other material type capable of providing spring like resilience and an adjusting device to provide a means of adjusting said base.

10. The adjusting device of claim 9 is any device that when operated allows or causes change in the mounting base from its at rest position.

11. A position sensor is attached to said mounting base of claim 9.

12. Said position sensor of claim 11 are a liquid or heavy metal filled switch, accelerometer, silicon controlled gyroscope or any device or combination of devices thereof capable of detecting angular deviation.
